(19) United States
(12) Patent Application Publication
(10) Pub. No.: US 2020/0127859 A1
(43) Pub. Date: Apr. 23, 2020

(54) COMMUNICATION SYSTEM USING TWO KINDS OF KEYS

(71) Applicant: MING-TSUNG CHEN, Taipei City (TW)

(72) Inventor: MING-TSUNG CHEN, Taipei City (TW)

(21) Appl. No.: 16/166,365

(22) Filed: Oct. 22, 2018

(51) Int. Cl. H04L 9/32; H04L 29/06; H04W 12/04

(52) U.S. Cl. CPC H04L 9/3297; H04W 12/04; H04L 9/3236; H04L 63/0428

(57) ABSTRACT

A communication system is provided in the present disclosure. The communication system includes a server, and a first electronic device having a first device preset key. When the first electronic device transmits the first type of data, the server verifies whether the first device preset key matches the first device key, to determine whether to allow the first electronic device to transmit the first type of data to the server. When the first electronic device transmits a second type of data to the server, the first electronic device encrypts and encodes a first time stamp and a second transmission key to generate a first hash value. The first electronic device transmits the first hash value to the server.

### FIELD OF THE DISCLOSURE

The present invention relates to a communication system, and in particular, to a communication system using two kinds of keys for transmission.

### BACKGROUND OF THE DISCLOSURE

By use of smart meters, a smart grid is increasingly popularized. At present, the smart meter uses either a wired network or a wireless network to transmit data. A smart grid system using the wireless network as the major transmission manner needs to further transmit other power protection signals in addition to power data. If the system uses the same key to conduct transmission, it is difficult to distinguish between the confidentiality levels.

In view of this, a communication system which can transmit data according to different confidentiality levels is provided, which is an important task in this field.

### SUMMARY OF THE DISCLOSURE

In response to the above-referenced technical inadequacies, the present disclosure provides a communication system using two kinds of keys for transmission, which includes: a server, and a first electronic device having a first device preset key. Before the first electronic device sends a first type of data to the server, the first electronic device provides a first transmission request signal corresponding to the first type of data to the server; the server generates a first device key according to the first transmission request signal, and provides a first verification request signal to the first electronic device according to the first transmission request signal; the first electronic device transmits the first device preset key to the server according to the first verification request signal; and the server verifies whether the first device preset key matches the first device key, to determine whether to allow the first electronic device to transmit the first type of data to the server. When the first electronic device transmits a second type of data to the server, the first electronic device encrypts and encodes a first time stamp and a second transmission key to generate a first hash value, and then transmits the first hash value to the server.

Before the first electronic device sends the second type of data to the server, the first electronic device provides a second transmission request signal corresponding to the second type of data to the server; and the server generates the second transmission key according to the second transmission request signal, and transmits the second transmission key generated by the server to the first electronic device.

The server generates a second hash value according to a second time stamp and the second transmission key, and compares the first hash vale with the second hash value, to determine whether to allow the first electronic device to transmit the second type of data to the server.

The confidentiality level of the first type of data is higher than that of the second type of data.

A time difference between the first time stamp and the second time stamp is less than predetermined duration.

The first time stamp and the second time stamp are equal.
Before the first electronic device sends another first type of data to the server, the first electronic device provides another first transmission request signal corresponding to the another first type of data to the server; the server generates another first device key according to the another first transmission request signal, and provides a first verification request signal to the first electronic device according to the another first transmission request signal; the first electronic device transmits the first device preset key to the server according to the first verification request signal; and the server verifies whether the first device preset key matches the another first device key, to determine whether to allow the first electronic device to transmit the another first type of data to the server.

The first electronic device communicates with the server according to the Bluetooth communication protocol 4.0 or 5.0.

The communication system also includes a second electronic device. The first electronic device and the second electronic device separately communicate with the server according to the Bluetooth communication protocol 4.0 or 5.0, and the second electronic device communicates with the server and the first electronic device according to the Bluetooth communication protocol 4.0 or 5.0.

In view of this, an embodiment of the present invention provides a communication method using two kinds of keys, including: transmitting a first transmission request signal corresponding to a first type of data; providing a first verification signal; providing a first device preset key according to the first verification signal; and verifying whether the first device preset key matches a first device key, to determine whether to transmit the first type of data.

The communication method further includes: transmitting a second transmission request signal corresponding to a second type of data; generating a second transmission key according to the second transmission request signal; returning the second transmission key; generating a first hash value according to the second transmission key and a first time stamp; generating a second hash value according to the second transmission key and a second time stamp; comparing the first hash value with the second hash value, to generate a comparison result; and determining, according to the comparison result, whether to transmit the second type of data.

To sum up, the communication system in the embodiment of the present invention uses two different kinds of keys to transmit different types of data, such that data of different confidentiality levels is transmitted in different encryption levels. Moreover, the two kinds of keys used in the present invention are available only for current data transmission, further improving the confidentiality level of the communication method of the present invention.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic diagram of a communication system according to an embodiment of the present invention;

FIG. 2 is a schematic diagram showing that communication is performed between a first electronic device and a server by using a first device key according to an embodiment of the present invention; and

FIG. 3 is a schematic diagram showing that communication is performed between a first electronic device and a server by using a second transmission key according to an embodiment of the present invention.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

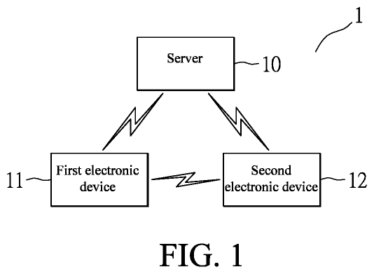

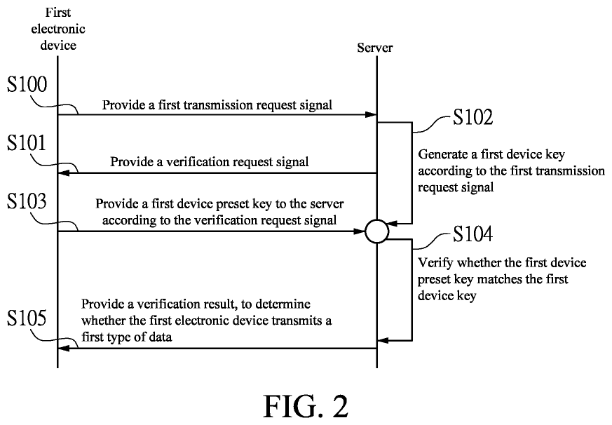

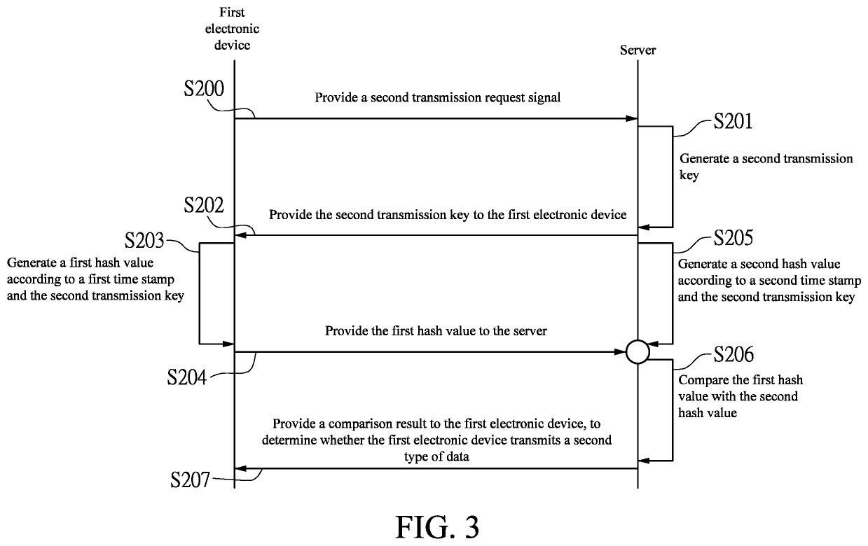

Referring to FIGS. 1, 2 and 3, FIG. 1 is a schematic diagram of a communication system according to an embodiment of the present invention, FIG. 2 is a schematic diagram showing that communication is performed between a first electronic device and a server by using a first device key according to an embodiment of the present invention, and FIG. 3 is a schematic diagram showing that communication is performed between a first electronic device and a server by using a second transmission key according to an embodiment of the present invention.

Referring to FIG. 1, in this embodiment, a communication system 1 includes a server 10, a first electronic device 11, and a second electronic device 12.

The first electronic device 11 and the second electronic device 12 separately communicate with the server 10 according to a first communication protocol. The first electronic device 11 communicates with the second electronic device 12 according to a second communication protocol. In this embodiment, the communication system 1 is applicable to a smart grid system.

In this embodiment, the first electronic device 11 and the second electronic device 12 are each a Bluetooth communication device. The first electronic device 11 and the second electronic device 12 may be separately mounted in a different smart meter or a different power loop control switch of the smart grid, which is not limited in the present invention.

In addition, the numbers of the first electronic device 11 and the second electronic device 12 can be adjusted according to an actual requirement. That is, the number of electronic devices communicatively connected to the communication system 1 can be adjusted and set according to an actual requirement, which is not limited in the present invention.

In this embodiment, the first communication protocol may be the Bluetooth communication protocol 4.0, Bluetooth communication protocol 5.0, Wifi communication protocol, LoRa communication protocol, Sigfox communication protocol, 4th generation mobile communication protocol (4G), or 5th generation mobile communication protocol (5G), which may be adjusted and set according to an actual requirement and is not limited in the present invention. The second communication protocol may be the Bluetooth communication protocol 4.0, Bluetooth communication protocol 5.0, Wifi communication protocol, LoRa communication protocol, Sigfox communication protocol, 4th generation mobile communication protocol (4G), or 5th generation mobile communication protocol (5G), which may be adjusted and set according to an actual requirement and is not limited in the present invention.

In this embodiment, the first electronic device 11 and the second electronic device 12 separately communicate with the server 10 according to the Bluetooth communication protocol.

The first electronic device has a first device preset key. A communication method performed between the first electronic device 11 and the server 10 to transmit a first type of data includes the following steps:

providing a first transmission request signal (step S100); providing a verification request signal (step S101); generating a first device key according to the first transmission request signal (step S102); providing the first device preset key to the server according to the verification request signal (step S103); verifying whether the first device preset key matches the first device key (step S104); and providing a verification result, to determine whether the first electronic device transmits the first type of data (step S105).

In this embodiment, before data transmission, the first electronic device 11 first detects the type of the data. That is, before transmitting a first type of data or a second type of data, the first electronic device 11 first detects which key and transmission manner are suitable for transmission of the data of the first type or the second type. That is, in this embodiment, a key is selected according to a confidentiality level and classification of the data.

In step S100, before transmission of the first type of data, the first electronic device 11 first provides a first transmission request signal corresponding to the first type of data to the server 10. Afterwards, the server 10 performs step S101 described above, that is, the server 10 provides a verification request signal to the first electronic device 11 according to the first transmission request signal.

In step S102, the server 10 generates a corresponding first device key according to the first transmission request signal.

In step S103, the first electronic device 11 provides the first device preset key to the server 10 according to the verification request signal. In this embodiment, the first device preset key is stored in the first electronic device 11. Moreover, the first device preset password is stored in isolation, and thus cannot be easily changed.

In step S104, the server 10 verifies the first device preset key transmitted by the first electronic device 11 and the first device key generated according to the first transmission request signal by the server 10, to determine whether the first device preset key matches the first device key; and generates a verification result.

In step S105, the server 10 provides the verification result to the first electronic device 11, to determine whether the first electronic device 11 transmits the first type of data. If the verification result shows that the first device preset key matches the first device key, the first electronic device 11 starts transmitting the first type of data; or if the verification result shows that the first device preset key does not match the first device key, the first electronic device 11 does not transmit the first type of data. In this embodiment, the first type of data has a relatively high confidentiality level.

In this embodiment, before the first electronic device 11 sends another first type of data to the server 10, the first electronic device 11 provides another first transmission request signal corresponding to the another first type of data to the server 10. The server 10 generates another first device key according to the another first transmission request signal, and provides a first verification request signal to the first electronic device 11 according to the another first transmission request signal. The first electronic device 11 transmits the first device preset key to the server 10 according to the first verification request signal. The server 10 verifies whether the first device preset key matches the another first device key, to determine whether the first electronic device transmits the another first type of data to the server 10.

Referring to FIG. 3, a communication method performed between the first electronic device 11 and the server 10 to transmit a second type of data includes the following steps:

providing a second transmission request signal (step S200); generating a second transmission key (step S201); providing the second transmission key to the first electronic device (step S202); generating a first hash value according to a first time stamp and the second transmission key (step S203); providing the first hash value to the server (step S204); generating a second hash value according to a second time stamp and the second transmission key (step S205); comparing the first hash value with the second hash value (step S206); and providing a comparison result to the first electronic device, to determine whether the first electronic device transmits the second type of data (step S207).

In this embodiment, before data transmission, the first electronic device 11 first detects the type of the data. That is, before transmitting a first type of data or a second type of data, the first electronic device 11 first detects which key and transmission manner are suitable for transmission of the data of the first type or the second type. That is, in this embodiment, a key is selected according to a confidentiality level and classification of the data.

In step S200, before transmitting the second type of data, the first electronic device 11 first provides a second transmission request signal corresponding to the second type of data to the server 10.

In step S201, the server 10 generates a second transmission key according to the second transmission request signal. In this embodiment, the second transmission key is a disposable key, and can be used only at the current transmission request. At another transmission request, a new second transmission key is required.

In step S202, the server 10 provides the second transmission key corresponding to the second transmission request signal to the first electronic device 11.

In step S203, the first electronic device 11 generates a first hash value according to a first time stamp and the second transmission key.

In step S204, the first electronic device 11 provides the first hash value to the server 10.

In step S205, the server 10 generates a second hash value according to a second time stamp and the second transmission key. In this embodiment, the first hash value and the second hash value respectively in steps S203 and S205 are obtained by means of a hash operation using the second transmission key and different time stamps.

In step S206, the server 10 compares whether the first hash value is consistent with the second hash value, to generate a comparison result.

In step S207, the server 10 provides the comparison result to the first electronic device 11, to determine whether the first electronic device 11 transmits the second type of data. If the comparison result shows that they are consistent, the first electronic device 11 transmits the second type of data; or if the comparison result shows that they are inconsistent, the first electronic device 11 does not transmit the second type of data.

In this embodiment, a time difference between the first time stamp and the second time stamp is less than predetermined duration. The predetermined duration is, for example, 5 seconds or 10 seconds. In other embodiments, the first time stamp may also be equal to the second time stamp.

In this embodiment, the confidentiality level of the first type of data is higher than that of the second type of data. That is, the first type of data may be power data, while the second type of data may be a notification signal, an alarm signal or a protection signal, which is not limited in the present invention.

To sum up, the communication system in the embodiments of the present invention uses two different kinds of keys to transmit different types of data, such that data of different confidentiality levels is transmitted in different encryption levels. Moreover, the two kinds of keys used in the present invention are available only for current data transmission, further improving confidentiality of the communication method of the present invention.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A communication system using two kinds of keys for transmission, comprising:
a server; and
a first electronic device, having a first device preset key, wherein
before the first electronic device sends a first type of data to the server, the first electronic device provides a first transmission request signal corresponding to the first type of data to the server; the server generates a first device key according to the first transmission request signal, and provides a first verification request signal to the first electronic device according to the first transmission request signal; the first electronic device transmits the first device preset key to the server according to the first verification request signal; and the server verifies whether the first device preset key matches the first device key, to determine whether to allow the first electronic device to transmit the first type of data to the server; and
when the first electronic device transmits a second type of data to the server, the first electronic device encrypts and encodes a first time stamp and a second transmission key to generate a first hash value, and then transmits the first hash value to the server.

2. The communication system of claim 1, wherein before the first electronic device sends the second type of data to the server, the first electronic device provides a second transmission request signal corresponding to the second type of data to the server; and the server generates the second transmission key according to the second transmission request signal, and transmits the second transmission key generated by the server to the first electronic device.

3. The communication system of claim 2, wherein the server generates a second hash value according to a second time stamp and the second transmission key, and compares the first hash vale with the second hash value, to determine whether to allow the first electronic device to transmit the second type of data to the server.

4. The communication system of claim 1, wherein the confidentiality level of the first type of data is higher than that of the second type of data.

5. The communication system of claim 3, wherein a time difference between the first time stamp and the second time stamp is less than predetermined duration.

6. The communication system of claim 3, wherein the first time stamp and the second time stamp are equal.

7. The communication system of claim 1, wherein before the first electronic device sends another first type of data to the server, the first electronic device provides another first transmission request signal corresponding to the another first type of data to the server; the server generates another first device key according to the another first transmission request signal, and provides a first verification request signal to the first electronic device according to the another first transmission request signal; the first electronic device transmits the first device preset key to the server according to the first verification request signal; and the server verifies whether the first device preset key matches the another first device key, to determine whether to allow the first electronic device to transmit the another first type of data to the server.

8. The communication system of claim 1, wherein the first electronic device communicates with the server according to the Bluetooth communication protocol 4.0 or 5.0.

9. The communication system of claim 1, further comprising:
a second electronic device, wherein
the first electronic device and the second electronic device separately communicate with the server according to the Bluetooth communication protocol 4.0 or 5.0, and the second electronic device communicates with the server and the first electronic device according to the Bluetooth communication protocol 4.0 or 5.0.

10. A communication method using two kinds of keys, comprising:
transmitting a first transmission request signal corresponding to a first type of data;
providing a first verification signal;
providing a first device preset key according to the first verification signal; and
verifying whether the first device preset key matches a first device key, to determine whether to transmit the first type of data.

11. The communication method of claim 10, further comprising:
transmitting a second transmission request signal corresponding to a second type of data;
generating a second transmission key according to the second transmission request signal;
returning the second transmission key;
generating a first hash value according to the second transmission key and a first time stamp;
generating a second hash value according to the second transmission key and a second time stamp;
comparing the first hash value with the second hash value, to generate a comparison result; and
determining, according to the comparison result, whether to transmit the second type of data.
